(19) United States
(12) Patent Application Publication
(10) Pub. No.: US 2013/0099895 A1
(43) Pub. Date: Apr. 25, 2013

(54) SYSTEM AND METHOD FOR FRIEND IDENTIFICATION

(71) Applicants: Ofer Harpak, Kiryat-Tivon (IL); Joseph Caspin, Haifa (IL)

(72) Inventors: Ofer Harpak, Kiryat-Tivon (IL); Joseph Caspin, Haifa (IL)

(21) Appl. No.: 13/180,561

(22) Filed: Jul. 12, 2012

Related U.S. Application Data
(60) Provisional application No. 61/363,284, filed on Jul. 12, 2010.

(51) Int. Cl. G06K 7/01

(52) U.S. Cl. CPC G06K 7/01
USPC 340/10.1

(57) ABSTRACT

A friend identification that may include: a first array of antennas, wherein main antenna lobes of different antennas of the first array partially overlap to define a first array lobe; wherein a beamwidth of the first array lobe is smaller than a beamwidth of each main antenna lobe of the different antennas of the first array; a transmission circuit arranged to provide to the first array of antennas a radio frequency (RF) interrogation signal; a reception circuit arranged to receive an RF response signal from an entity to be classified as a friend and to provide an electrical representation of the RF response signal; and a processor, arranged to process the electrical representation of the response signal and to determine, based on the electrical representation of the RF response signal, whether the entity is a friend.

### RELATED APPLICATIONS

This application claims priority from U.S. provisional patent Ser. No. 61/363,284, filing date Jul. 12, 2011 which is incorporated herein in its entirety.

### DESCRIPTION OF THE INVENTION

### Background of the Invention

During the last coupled of years the need to classify entities as friends (or foes) has dramatically increase due to the nature of modern combat field (especially urban combat fields) and an increase in the lethality of modern weapons.

### SUMMARY OF THE INVENTION

According to an embodiment of the invention an identification friend identification system may be provided and may include: a first array of antennas that may include a plurality of antennas, wherein main antenna lobes of different antennas of the first array partially overlap to define a first array lobe; wherein a beamwidth of the first array lobe is smaller than a beamwidth of each main antenna lobe of the different antennas of the first array; a transmission circuit may be arranged to provide to the first array of antennas a radio frequency (RF) interrogation signal; a reception circuit, coupled to the first array of antennas, may be arranged to receive an RF response signal from an entity to be classified as a friend (and may also be used for classifying an entity as a foe) and to provide an electrical representation of the RF response signal; and a processor, may be arranged to process the response signal and to determine, based on the electrical representation of the RF response signal, whether the entity is a friend or a suspected foe. According to an embodiment of the invention a method for classifying an entity as a friend, is provided. The method may include providing, by a transmission circuit and to a first array of antennas, a radio frequency (RF) interrogation signal; wherein the first array of antennas may include a plurality of antennas, wherein main antenna lobes of different antennas of the first array partially overlap to define a first array lobe; wherein a beamwidth of the first array lobe is smaller than a beamwidth of each main antenna lobe of the different antennas of the first array; transmitting by the first array of antennas the RF interrogation signal; receiving, by the first array of antennas, an RF response signal from the entity; and determining, based on the RF response signal, whether the entity is a friend

The first array of antennas may include at least three different antennas.

The main antennas may be shaped and positioned so that first array lobe is defined by an overlap of all of the main lobes of all of the antennas of the first array.

The first array of antennas may include a first array lobe alteration circuit may be to arranged to alter at least one characteristic of at least one main lobe of the antennas of the first array of antennas such as to alter at least one first array lobe characteristic selected from a group consisting of a direction of the first array lobe, a beamwidth of the first array lobe and a shape of the first array lobe.

The identification system may be arranged to provide to the first array of antennas an encoded RF interrogation signals and wherein either one of the reception circuit and the processor is may be arranged to decode an encoded response signal.

Either one of the reception circuit and the processor is may be arranged to extract from the response signal status information relating to the entity.

The identification system may include a unidirectional antenna.

The processor may be arranged to evaluate a distance to the entity based on (a) time lapsed between a transmission of the RF interrogation signal and a reception of the response signal, and (b) a delay introduced by the entity between a reception the RF interrogation signal and a transmission of the response signal.

The processor may be coupled to a fire control element, and may be arranged to instruct the fire control element to prevent a detonation of ammunition or firing towards the entity, if the processor determines that the entity is a friend.

The first array of antenna may include antennas that are either one of Helli-coil antennas, patch antennas, dielectric rod antennas, Yagi-Huda monopole antenna and surface wave antennas.

The identification system may include a second array of antennas that may include a plurality of antennas, wherein main antenna lobes of different antennas of the second array partially overlap to define a second array lobe; and wherein a beamwidth of the second array lobe is smaller than a beamwidth of each main antenna lobe of the different antennas of the second array; wherein a first frequency range of the first array of antennas differs from a second frequency range of the second array of antennas.

The second array of antennas may include at least three different antennas.

A central frequency of the first frequency range differs from an integer multiple of a central frequency of the second frequency range and wherein the central frequency of the second frequency range differs from an integer multiple of the central frequency of the first frequency range.

The first frequency range may include a frequency of 2.4 Giga-Hertz and wherein to the second frequency range may include a frequency of 24 Giga-hertz.

The first frequency range may include at least one frequency out of a frequency range of 70-90 Gigahertz and wherein the second frequency range may include at least one frequency out of a frequency range of 0.4-2.4 Gigahertz.

The second array of antennas may include a second array lobe alteration circuit may be arranged to alter at least one characteristic of at least one main lobe of the antennas of the second array of antennas such as to alter at least one second array lobe characteristic selected from a group consisting of a direction of the second array lobe, a beamwidth of the second array lobe and a shape of the second array lobe.

The first array of antennas may be encloses in a cylindrical housing having a radius that does not exceed 3 centimeters and having a length that does not exceed 30 centimeters. It is noted that the housing can have other shapes (for example—a polygon) and other dimensions (more than 3 centimeters in width or height).

An overall angular coverage obtained by all of the antennas of the first array exceeds 10 degrees by 10 degrees while the angular coverage of the first array lobe does not exceed 1 degree by 1 degree.

The transmission circuit is may be arranged to provide in parallel the RF interrogation signal to all of the antennas of the first array of antennas.

The transmission circuit is may be arranged to provide the RF interrogation signal to different antennas of the first array of antennas in a sequential manner—one antenna after the other.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrate a portion of a first array of antennas according to an embodiment of the invention;

FIG. 2 illustrates a cross sectional view of a first array of antennas according to various embodiments of the invention;

FIG. 3 illustrates an identification system and an IF transceiver according to an to embodiment of the invention;

FIG. 4 illustrates an identification system according to an embodiment of the invention;

FIG. 5 illustrates various antennas of the first array of antennas, according to various embodiments of the invention;

FIG. 6 illustrates various main lobes of various antennas according to various embodiments of the invention;

FIG. 7 illustrates a RF processing of signals received from a first array of antennas, according to various embodiments of the invention;

FIG. 8 illustrates a method according to various embodiments of the invention; and

FIG. 9 illustrates a method according to various embodiments of the invention.

### DETAILED DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views.

Because the illustrated embodiments of the present invention may for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

Subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in to order to provide a thorough understanding of the invention. However, it will be understood by those skilled in the art that the present invention may be practiced without these specific details. In other instances, well-known methods, procedures, and components have not been described in detail so as not to obscure the present invention.

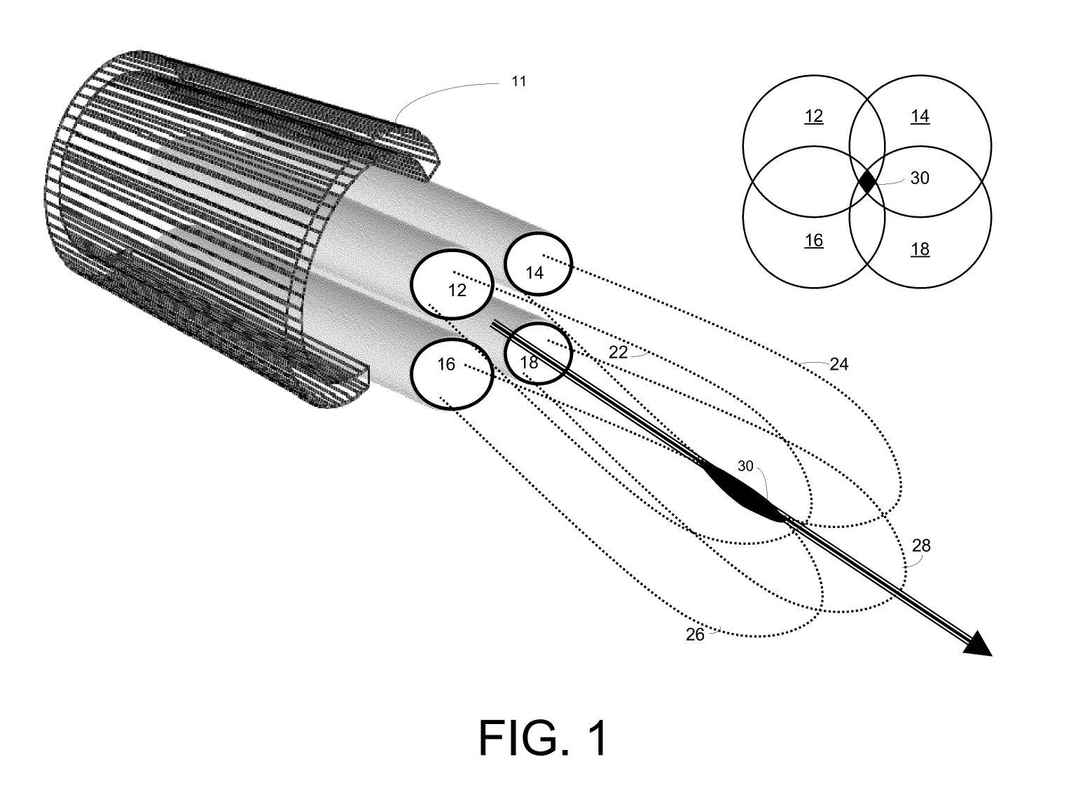

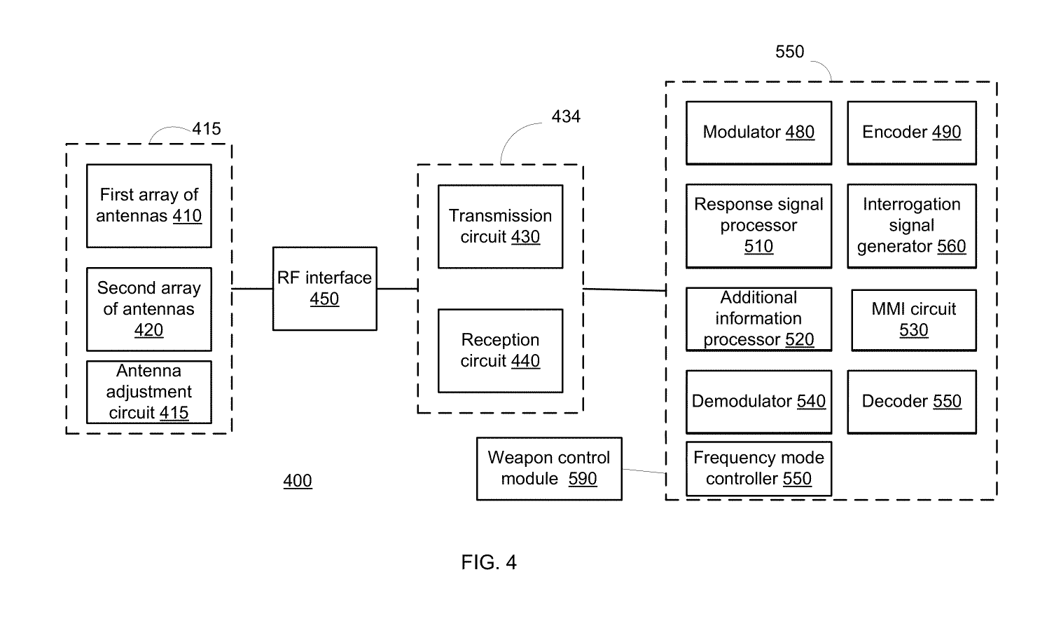

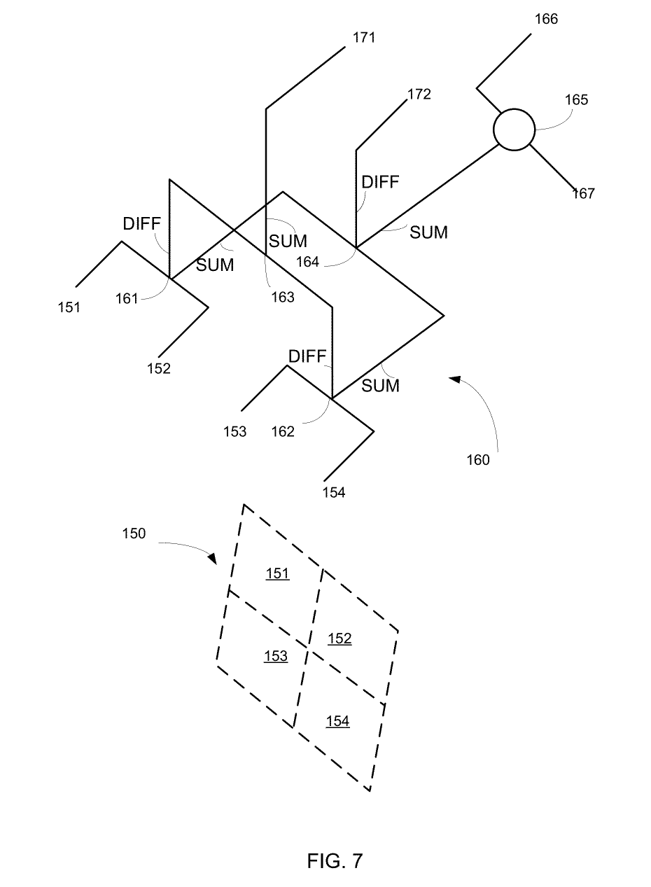

FIG. 1 illustrates a portion of an identification system, according to an embodiment of the invention. The identification system includes an array of antennas that include multiple directional antennas, arranged so that each of the reception lobes (and/or transmission lobes) of the multiple directional antennas partly overlap with the reception lobe (and/or transmission lobe respectively) of at least one other directional antenna of the identification system, and according to some embodiments of the invention with the reception lobes (and/or transmission lobes respectively) of at least two (or three, four, etc.) other directional antennas of the identification system. FIG. 4 illustrates four antennas 12, 14, 16 and 18 that are arranged as a rectangular grid of two rows and two columns The antennas 12, 14, 16 and 18 have main lobes 22, 24, 26 and 26 respectively that overlap (area 30) to provide a first array lobe 30. The first array lobe 30 represents the overlap area and virtually represents a possible processing process of a response signal—only when all antennas 12, 14, 16 and 18 receive a response signal it is declared that a response signal was received. The processing can be done in the electrical domain, or at the RF domain (as illustrated in FIG. 7). FIG. 1 also illustrated a direction 28 of view of the identification system—that corresponds with the first array lobe 30. FIG. 1 also illustrates an enclosure 11 that surrounds the antennas 12, 14, 16 and 18 and may protect these antennas from being damaged.

Especially, according to some embodiments of the invention, the multiple directional antennas of the identification system are arranged so that each of the reception lobes (and/or transmission lobes) of the multiple directional antennas partly overlap with the reception lobes (and/or transmission lobes respectively) of all of the other multiple directional antennas. The overlapping area is exemplified in the blackened area 30 of FIG. 1. Clearly, the lobes are illustrated out of proportion with respect to the identification system.

Each of the multiple directional antenna can detect a Friend identifier (usually carried by a friendly unit, such as a foot-soldier, a tank, an aircraft, a worker, a colleague, and so forth), and provide indication of such detection. However, the lobe of each individual antenna is usually relatively wide, and therefore such indication is not sufficient for much utilization, especially in the modern battlefield. Therefore, the disclosed identification system combines information received from multiple antennas in order to provide substantially more accurate information regarding the exact direction of the signal detected by the respective directional antennas.

The identification system includes a processor, configured to receive detection information from the multiple directional antenna (detection information indicative of detection of friendly unit, or failure of such detection), and further configured to process the detection information received from the multiple antennas to determine the direction of the friendly unit.

For example, the processor may determine that the friendly unit is located in the direction of a predefined axis of the system (e.g. the sights line) only if the friendly unit is detected by all of the multiple directional antennas.

In another example, the processor may be able to determine that the friendly unit is located in a determined direction off that predefined axis (e.g. to the left of it), if the friendly unit is detected by only some of the multiple directional antennas (e.g. by the antennas directed more toward the left side).

It is noted that, according to an embodiment of the invention, the arrangement of the antennas may be modified (either by mechanically moving the antennas or other lobe modifying component of the identification system, or by modifying electrical parameters of the antennas), so as to modify the amount of over-lapping between the lobes of the multiple directional antennas. This may enable changing the sensitivity of the identification system to deviation from the predetermined axis. This may enable both taking into account different types of utilization (e.g. different types of weapons and/or of targets) and compensating for fluctuations in the shape of the lobes in different situations, if occurs. According to an embodiment of the invention, the system may be calibrated, wherein the calibration includes detecting a calibration target in a known distance and size, and arranging the multiple directional antennas according to the detection results generated by the processor.

It is noted that conveniently the identification system may include three or more antennas, which facilitate determination of three dimensional direction information. Conveniently, the multiple directional antennas of the identification system are arranged in a symmetrical manner (e.g. around the predetermined axis), but this is not necessarily so.

It is noted that the system can transmit an interrogating signal using one or more antennas of the array of antennas and that one or more transmitting antenna used for transmission can differ from the array of antennas that are used for reception.

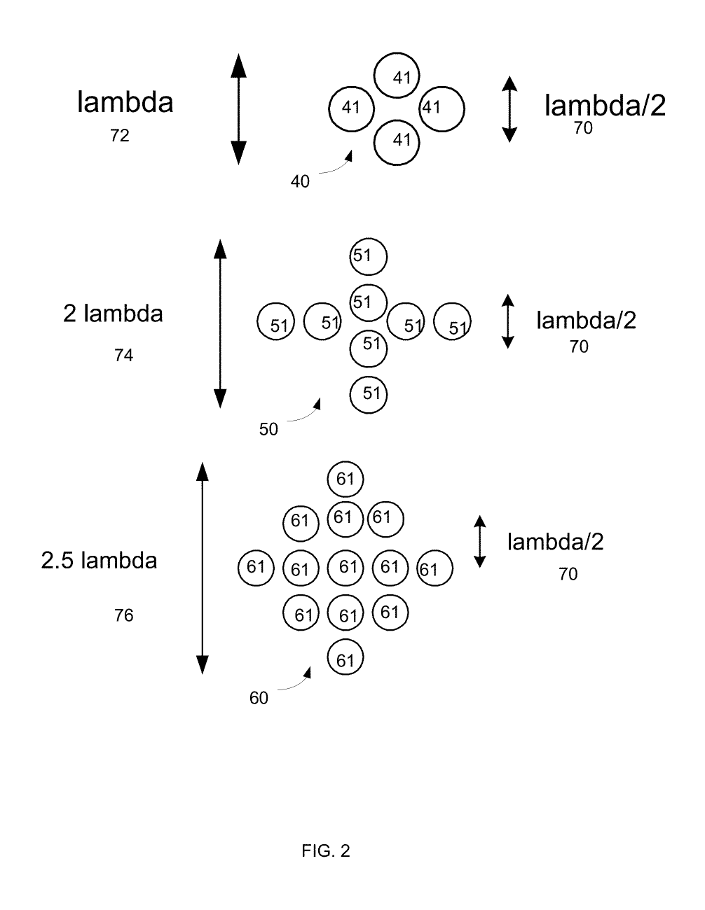

FIG. 2 illustrate some arrangements of directional antennas that are implemented in some embodiments of the invention. It is noted that different configurations of multiple directional antennas may be adapted to different frequencies used by the directional antennas (e.g. as exemplified in FIG. 2), which in turn may be useful for different utilizations. For example, different types of targets (e.g. aircraft, tanks, and people) or of environments (e.g. sea, battlefield, and city) may necessitate different wavelengths used.

FIG. 2 illustrates a front view of three different antenna arrays. The first array 40 includes four antennas 41 that are arranged as a rhombus. The diameter of each antenna is one half a wavelength 72 of a 10 GHz signal, and the height of the first array is about one wavelength 72. The second array 50 includes eight antennas 51 that are arranged as a cross. The diameter of each antenna 51 is one half a wavelength 72 of a 20 GHz signal, and the height of the second array is about two wavelengths 74. The third array 60 includes thirteen antennas 61 that are arranged as a rhombus. The diameter of each antenna is one half a wavelength 72 of a 24 GHz signal, and the height of the third array is about two and a half wavelengths 76.

A single identification system can include one or more antenna arrays—such as but not limited to a combination of one or more of first array 40, second array 50 and third array 60.

It is noted that conveniently, the directional antennas have means for identifying that detected radiation is received from the friendly unit. This may be done in various manners, many of which are known in the art. According to an embodiment of the invention, the directional antennas may be adapted to receive coded signals received from the friendly unit, and to provide detection information in response to decoding of the coded signal and identification thereof.

Since in some situations, it is not desirable for the friendly unit to transmit information without knowing who is querying it, according to an embodiment of the invention, some or all of the directional antennas are further configured to transmit an identifiable (e.g. coded) signal which is identifiable by the friendly unit and which is conveniently sufficient for the friendly unit to identify the signal as a querying signal issues by a friendly identification system (and possibly also which system).

It is noted that the coded signal received by the identification system from the friendly unit (if applicable) may provide additional information regarding the friendly unit (i.e. in addition to its being friendly), such as its identity. It is noted that, according to an embodiment of the invention, the coded received signal may be coded by the friendly unit to include additional information which may change from time to time (e.g. status, task, etc.). Likewise, in some embodiments the identification system may code its signals similarly (e.g. reason for querying).

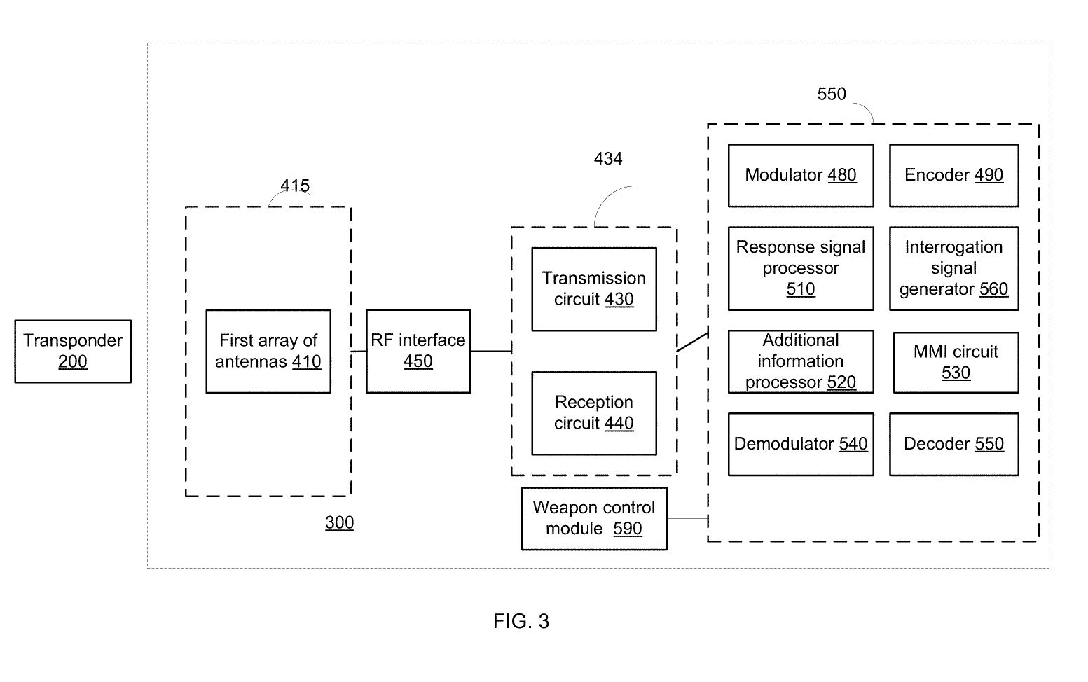

FIG. 3 illustrates an identification system 300 and a transponder 200 according to an embodiment of the invention. The transponder 200 may include a battery, a transceiver and include processing capabilities for decoding, encoding, encryption, decryption and the like.

The “transponder” may be used by the friendly unit, and components that may be implemented in the identification system (e.g. by the processor thereof). It is noted that the responding unit of the friendly unit may be of different types and sizes, e.g. depending on the type of friendly unit. For example, a foot soldier may have a responding unit not much larger than a dog tag, while that of a civic ship may be much larger. According to an embodiment of the invention, the responding unit of the friend unit may be a radio frequency identification tag (RFID tag, e.g. passive UHF RFID tags). According to an embodiment of the invention, the responding unit may use some of the energy of the identification system signal in order to operate and to transmit the responding signal.

Some of the utilization for which the identification system may be used are:
i. A stand alone interrogator (e.g. for infantry); may be a stand alone unit and may be incorporated into binoculars, night vision goggles, etc (e.g. having a range of 2000 m);
ii. A small-arms mounted interrogator (e.g. having an angular coverage of 1°, and a range of 1000 m)
iii. Integrated into a rocket, missile etc. (e.g. having an angular coverage of 1° and a range of 3000 m)
iv. Integrated into a command and control (e.g. C²I, C⁴I, C⁴ISR, etc.) system or unit (e.g. for counting personal passing through a check point, having a range of 50 m);
v. Mounted on tank or similar vehicle, possibly integrated into the electro-optical sights system (e.g. having a range of 5000 m and an angular coverage of 1°);
vi. Airborne system (e.g. having an over all angular coverage similar to the of the head-up display, a spatial coverage of 1°, and a range of 10 Km);
vii. Integrated into a surveillance camera, homeland security system and so on, etc.

It is noted that in embodiments in which the configuration of the antennas may be modified, a single identification system may have different such utilizations.

It is also noted that clearly, the identification system may have different sizes, depending on the utilization. By way of illustration, a small-arms-mounted identification system may have a diameter of 3cm and light weight, incorporating four directional antennas, while a tank-mounted identification system or a stationary system may be much larger and incorporate thirteen larger and more powerful directional antennas.

It is noted that, conveniently, all the multidirectional antennas of the identification system may be enclosed in a single durable casing (such as illustrated in FIG. 1), but this is not necessarily so.

The identification system 300 and the transponder 200 may have different configurations—depending on the utilization and on the characteristics of the identification system 300 and the transponder 200, it may have different attributes.

For example, the identification system 300 and the transponder 200 may and may not have Omni-directional reception and/or transmission capabilities, it may have different thresholds of reception energy and different levels (possibly flexible) transmission power levers, it may have encryption capabilities, and it may and may not have an internal power source.

According to an embodiment of the invention, the transponder 200 may respond in a predetermined timing (e.g. 50ms after reception of the identification system signal), and thus facilitate estimation of distanced from friendly unit by the identification system. It is also noted that not necessarily all the multiple directional antennas of the identification system have similarly shaped lobes, and if some of the lobes are longer than other, it may also serve as an indication for distance.

Referring again to the identification system, it is noted that the identification system may have an internal power source, and/or may receive power from an external source.

identification system 300 includes an antenna module 415 that includes a first array of antennas 410, an RF interface 450 between the antenna module 415 and a transceiver module 434 that include a transmission circuit 430 and a reception circuit 440, and a processor 555 that is illustrated as including a modulator 480, encoder 490, response signal processor 510, an interrogation signal generator 560, an additional information processor 520, a man machine interface (MMI) circuit 530, a demodulator 540, and a decoder 550. The processor 550 can be connected to a weapon control module 590 that may, for example, be connected to a weapon fire control unit and may prevent firing on a friend or allow firing on a suspected foe. The weapon control module 590 can be mechanically coupled or electronically coupled to the weapon fire control unit and may physically prevent firing, capable of transmitting electromagnetic signals (wired or wirelessly) to the weapon fire control unit, and the like.

The RF interface 450 can perform RF up-conversion, RF down-conversion, RF processing of signals (as illustrated in FIG. 7), may control he provision (serial, parallel or hybrid) of interrogation signals to antennas of the first array 410, and can control the provision of RF signals from the antennas to the transceiver module(serial, parallel or hybrid), and the like.

The transceiver module 434 can perform signals conversions (frequency shifting) can perform modulation, demodulation and various other functions illustrated as being included in the processor 550.

The processor 550 can generate an interrogation signal (140), can modulate it (box 480), encode it (box 490) or both and send the interrogation signal to the transceiver module 434.

The processor 550 can receive a response signal from the transceiver module 434, can demodulate it (box 540), decode it (box 550) or both.

The processor can process the response signal (box 510) to determine whether the to entity that responded to the interrogation signal is a friend. The processing can also include defining an entity that did not respond to the interrogation signal within a predefined window as a suspected foe.

The processor 550 can extract (box 520) additional information from the response signal such as identifier, status and the like.

The processor can also control (box 530) a man machine interface (MMI) that may generate signals (video, audio or both) to indicate a friend or foe determination and additional information such as estimated position (distance, direction) of the entity.

The processor 550 of the identification system 300 (or another component thereof) may also carry out different operations in response to detection of the friendly unit, and so does any system that receives such information from the processor.

For example, a positive detection of a friendly unit may result in indicating its direction in an electro-optical system, it may disable a detonator of a missile or prevent triggering of a weapon, it may send a message over wired/wireless communication, and so forth.

As aforementioned, different implementations of the invention may be used for different types of systems and scenarios (both of targets and of interrogators). One implementation includes an interrogation system that is mounted on small-arms such as guns, machine guns, portable weapons, etc.

According to an embodiment of the invention, implementing of a small-arms mounted system (or equivalently small and light system) requires building an antenna or antenna array with angle of 1 degree at reasonable frequency band 400 MHz to 70 GHz is a big one.

Requirements for such systems may include, by way of example, small size (e.g. that enables installation of the system on a personal weapon such as M16)—wherein such size may be, by way of example, enclosed within a tube having a diameter of less than 30 mm, and using frequency band with good propagations for up to 1 Km or few Km.

According to an embodiment of the invention, a frequency of 20-30 GHz may be used, that may enable good propagations for up to 1 Km or few Km.

Yet according to another embodiment of the invention, a frequency that is within the range of 1-5 GHz may be used, as it exhibits improved penetration properties.

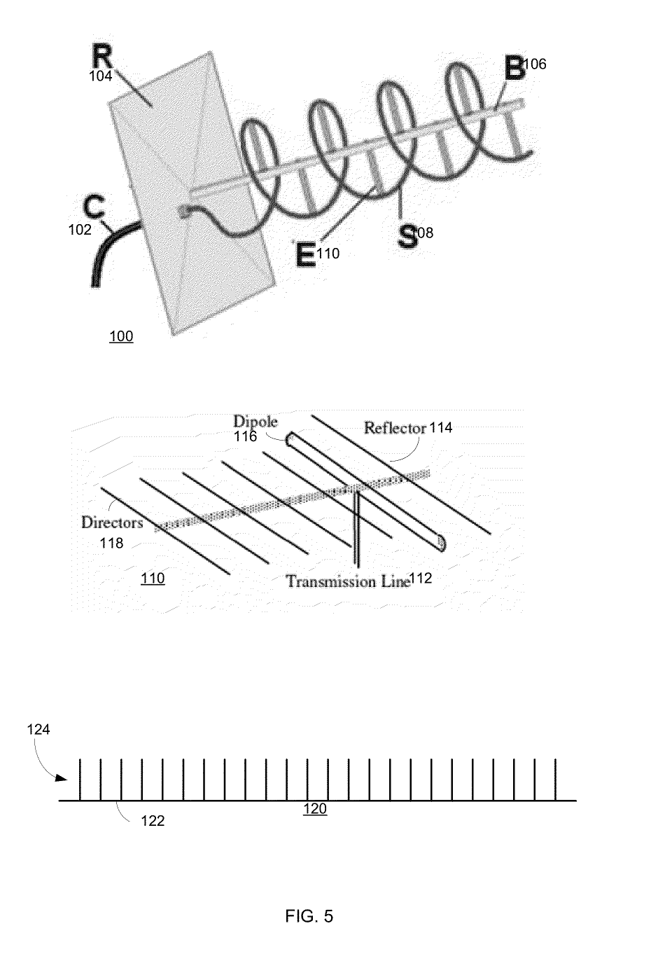

Different antenna arrays may be used in different embodiments of the invention. According to an embodiment of the invention, the antenna array includes four Heli-coil antennas or patch antennas or other kind of antennas, wherein the four antennas are not lined up (e.g. they may be arranged in the 2×2 formation of FIG. 1), so as to allow angular resolution of under 1 degree when detecting signal direction (e.g. from the friendly unit). Some of these antennas are illustrated in FIG. 5.

FIG. 5 illustrate various types of antennas that may be implemented in different embodiments of the identification system. Those types of antennas are helical antennas, dialectic rods antennas, and Yagi-Uda monopole type antennas. It is noted that other types of directional antennas and of directional antenna-arrays may also be implemented. For example, some other types are surface wave antennas, printed patches, and so forth

FIG. 5 illustrates a Helli-coil antenna 100 that includes a feeding cable 102, a reflector 104, a spiral conductor 108, a supporting elongated rod 106 and supporting elements 110 that connect the spiral 108 to the supporting elongated rod 106.

FIG. 5 also illustrates a Yagi-Uda monopole antenna 110 that includes reflector 114, a dipole 116, one or more directors 118 and a transmission line 112.

FIG. 5 also illustrates a dielectric antenna that includes multiple dielectric conductors that may include a base conductor 122 that is connected to an array 124 of parallel conductor 124.

Additional features may be implemented in various embodiments of the systems—in systems of different sizes. For example, according to an embodiment of the invention, the system utilizes at least one array of antennas that implement one or more frequency ranges—that are not necessarily sequential in respect to one another.

According to an embodiment of the invention, another/additional frequency is used—which may be a multiplication of the first frequency, but not necessarily so. Such another/additional frequency (or frequency range) implemented may enable the system to cross walls or other obstacles, and/or to use a similar antenna on the responder.

By way of example, according to an embodiment of the invention, a frequency of 24 GHz is used as the main frequency, and the system is further configured to transmit another signal at 2.4 GHz (that have better wall penetration). In that sort of implementation, if the friendly unit (e.g. a foot soldier) is beyond a wall and the interrogator system is installed on a tank that can shoot beyond wall—or through wall—the system will transmit in two or more available frequency ranges, either concurrently or serially (e.g. once with ˜24 GHz and afterwards with ˜2.4 GHz).

According to an embodiment of the invention, the responder of the friendly unit (e.g. on the soldier) will respond to both signal if received.

It is noted that if the second frequency is a whole multiple of the first frequency (e.g. f₂'N·fₜ, where N is an integer), a single antenna array may be used for both frequencies. It is noted that more than two frequencies may be used.

FIG. 4 illustrates components of the identification system 400, according to an embodiment of the invention.

System 400 includes an additional array of antennas—a second array of antennas 420 and also includes an antenna adjustment circuit 415.

There can be more than two antenna arrays in the identification system. The antenna adjustment circuit 415 can also be included in system 300. System 400 also includes a frequency mode controller 550 for determining in which frequency mode to operate.

The antenna adjustment circuit 415 can be arranged to alter at least one characteristic of at least one main lobe of the antennas of the first array of antennas such as to alter at least one first array lobe characteristic selected from a group consisting of a direction of the first array lobe, a beamwidth of the first array lobe and a shape of the first array lobe. The antenna adjustment circuit 415 can mechanically move one antenna in relation to the other, mechanically change the angle between different antennas and the like. This can be done by screws, bolts or other elements known in the art.

Referring to airborne identification systems, it is noted that such a system may be used for identification of other aircrafts, and/or for detection of ground units.

Referring to the later, it is noted that the identification system may have coverage of 20 degrees by 20 degrees an angular resolution of one by one degrees. The time for surveying and locating of a friendly unit may be about 5 seconds, and detection ranges of 10 Km.

It is noted that identification system s according the invention may be adapted to operate in an environment that is saturated with other electromagnetically radiating systems (e.g. also other identification system s).

It is noted that different embodiments of the identification system may implement different working frequencies for the multiple directional antennas. For example, one working possible frequency range is 70-90 gigahertz (GHZ), which is characterized by LOS without reflections, decay after limited range (i.e. with reduced radiation), and by a small sized directional antennas.

A second possible frequency range is 400-2400 MHZ, that is characterized by high filtration capabilities (e.g. through trees, thin walls, etc.), by longer range, and by an antennas-array for direction capabilities, and by cheaper and more available components.

It is noted that whenever the term directional antenna is used, it may be replaced by an antennas-array (e.g. a phased-array configuration).

Considering an embodiment of the invention in which the identification system is relatively small, e.g. if it is mountable on small arms, or integrated into binoculars. If the diameter of the identification system is, by way of example, D=3 cm, than it is λ/2 at 5 GHz; λ at 10 GHz; and 2λ at 20 GHz.

At 10 GHz with L≈4λ we can expect: 25°<θ<35°. Even at 10 GHz and above a monopulse or conical scan configuration is needed. It is noted that at least 4 end fire antennas may be configured inside a D=3 cm casing. The antenna depth may be, by way of example, about 12 cm.

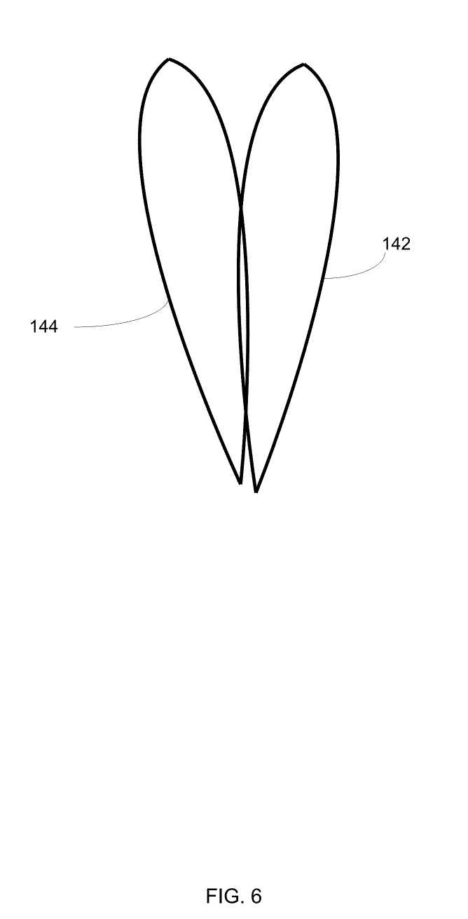

FIG. 6 illustrates monopulse and effective beamwidth that may be implemented in various embodiments of the invention. FIG. 6 can illustrate two lobes that can act as reception lobes, transmission lobes or both. A transmission may start by transmitting an interrogation signal to a first antenna that has a first lobe 142 and end by transmitting the interrogation signal to a second antenna that has a second lobe 144.

The reception may start by receiving a response signal by the first antenna that has the first lobe 142 and end by receiving a response signal by the second antenna that has the second lobe 144.

FIG. 7 illustrate monopulse characteristics that may be implemented in various embodiments of the invention.

FIG. 7 illustrates a RF processing of pulses received by an array of antennas 150 that includes an upper left antenna 151, an upper right antenna 152, a lower left antenna 153 and a lower right antenna 154. A front vie of this array of antennas is illustrated by a 2×2 matrix of dashed lines.

Signals from antennas 151 and 152 are provided to a first RF adder subtraction circuit 161 that outputs: (a) a sum (SUM) signal reflecting the sum of these signals—this SUM signal is sent to a third RF adder subtraction circuit 164, and (b) a difference signal (DIFF) signal reflecting the difference between these signals—this DIFF signal is sent to an RF adder 163.

Signals from antennas 153 and 154 are provided to a second RF adder subtraction circuit 162 that outputs: (a) a sum (SUM) signal reflecting the sum of these signals—this SUM signal is sent to the third RF adder subtraction circuit 164, and (b) a difference signal (DIFF) signal reflecting the difference between these signals—this DIFF signal is sent to the RF adder 163.

The RF adder 163 outputs a SUM signal 171 indicative of an azimuth of the response signal.

The SUM signals from the first and second RF adder subtraction circuits 161 and 162 are received by the third RF adder subtraction circuit 164 that outputs: (a) a sum (SUM) signal reflecting the sum of these signals—this SUM signal is sent to a receiver 167 via a circulator 165, and (b) a difference signal (DIFF) signal 172 reflecting an elevation of the response signal.

The circulator 165 is also coupled to a transmitter 166 that may provide an interrogation signals to antennas 151, 152, 153 and 154 via the various RF components discussed above—161, 162 and 164.

It is noted that the antennas of the identification system may achieve effective Beamwidth by Sequential lobing, by Monopulse, by displaced dual monopulse, and by other techniques known in the art.

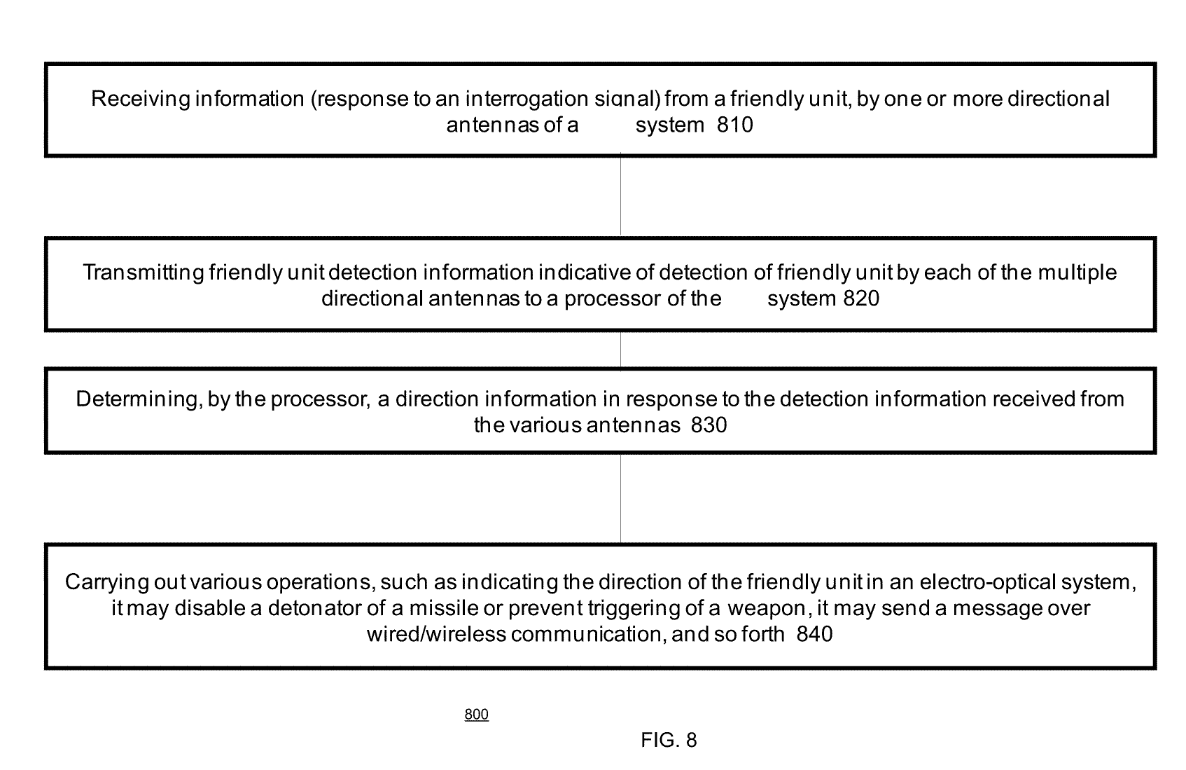

FIG. 8 illustrate a method for friend or foe identification, according to an embodiment of the invention. It is noted that the method may be carried out by the various embodiments of the above disclosed identification systems.

The method may start with stage 810 of receiving information (response to an interrogation signal) from a friendly unit, by one or more directional antennas of an identification system that implements the method (it is noted that this stage may be to preceded by a stage of transmitting a signal or signals toward the friendly unit by one or more of those antennas).

The method continues with stage 820 of transmitting friendly unit detection information indicative of detection of friendly unit by each of the multiple directional antennas to a processor of the identification system.

The method continues with stage 830 of determining, by the processor, a direction information (which may be the actual estimated direction, may be indication of whether the angular difference of the direction from a predetermined axis is larger than a known threshold, and so on), in response to the detection information received from the various antennas.

This stage may be followed by stage 840 of carrying out various operations, such as indicating the direction of the friendly unit in an electro-optical system, it may disable a detonator of a missile or prevent triggering of a weapon, it may send a message over wired/wireless communication, and so forth.

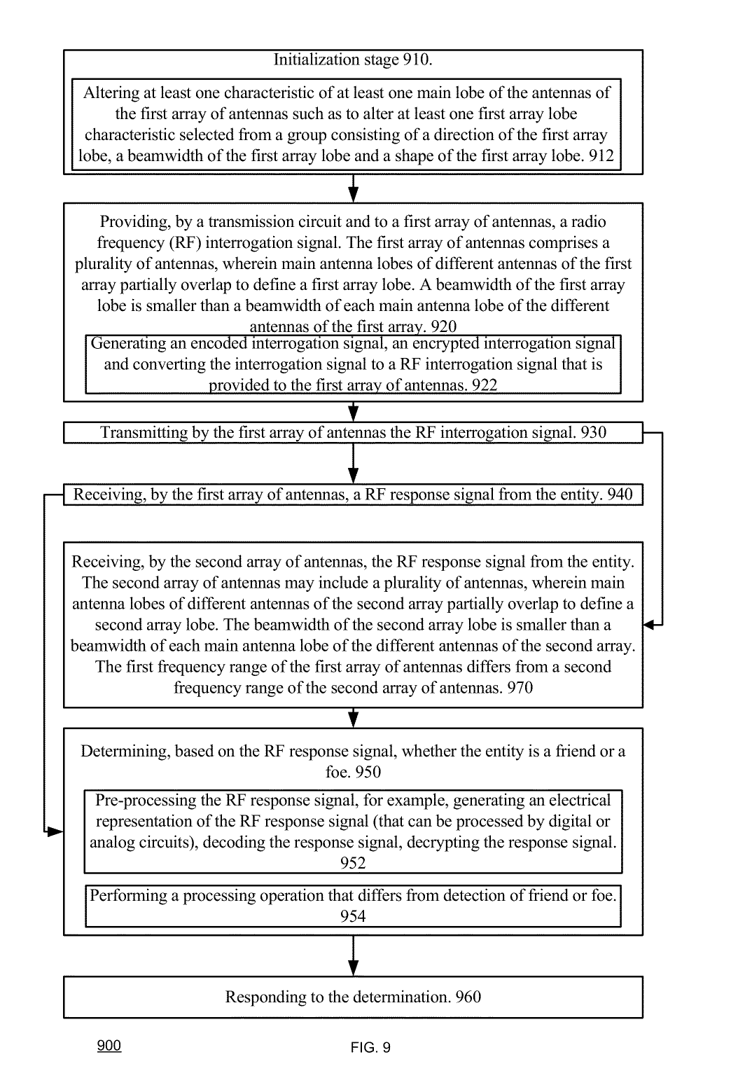

FIG. 9 illustrates method 900 according to an embodiment of the invention.

Method 900 may start by initialization stage 910. This stage can be used for calibrating the identification system. For example, stage 910 can include stage 912 of altering at least one characteristic of at least one main lobe of the antennas of the first array of antennas such as to alter at least one first array lobe characteristic selected from a group consisting of a direction of the first array lobe, a beamwidth of the first array lobe and a shape of the first array lobe.

Stage 910 may be followed by stage 920 of providing, by a transmission circuit and to a first array of antennas, a radio frequency (RF) interrogation signal. The first array of antennas comprises a plurality of antennas, wherein main antenna lobes of different antennas of the first array partially overlap to define a first array lobe. A beamwidth of the first array lobe is smaller than a beamwidth of each main antenna lobe of the different antennas of the first array.

The RF interrogation signal can belong to a frequency range out of multiple frequency ranges. The selection of the frequency range can be made by an operator of the IFF, according to a predefined schedule, in response to ambient conditions, success or failure of previous interrogation attempts and the like.

Stage 920 may include stage 922 of generating an encoded interrogation signal, to an encrypted interrogation signal and converting the interrogation signal to a RF interrogation signal that is provided to the first array of antennas.

Stage 920 is followed by stage 930 of transmitting by the first array of antennas the RF interrogation signal.

Stage 930 is followed by stage 940 of receiving, by the first array of antennas, a RF response signal from the entity.

Stage 940 may including at least one of the following:
i. Receiving the RF response signal by a first array of antennas that includes at least three different antennas.
ii. Receiving the RF response signal by a first array of antennas, wherein the main antennas are shaped and positioned so that first array lobe is defined by an overlap of all of the main lobes of all of the antennas of the first array.
iii. Receiving the RF response signal by a first array of antenna that may include at least one of Helli-coil antennas, patch antennas, dielectric rod antennas, Yagi-Huda monopole antenna and surface wave antennas.

Stage 940 is followed by stage 950 of determining, based on the RF response signal, whether the entity is a friend or a suspected foe.

Stage 950 may include (or may be preceded by) stage 952 of pre-processing the RF response signal, for example, generating an electrical representation of the RF response signal (that can be processed by digital or analog circuits), decoding the response signal, decrypting the response signal.

According to an embodiment of the invention stage 950 is also followed by (or executed in parallel) to stage 954 of performing a processing operation that differs from detection of friend or foe. The processing operation is applied on the electrical representation of the RF response signal or on the RF response signal itself. Stage 950 may include at least one of the following operations: extracting azimuth information, extracting elevation information, extracting additional information such as entity identifier, entity status, evaluating a distance to the entity based on (a) time lapsed between a transmission of the RF interrogation signal and a reception of the response signal, and (b) a delay introduced by the entity between a reception the RF interrogation signal and a transmission to of the response signal.

Stage 950 can be followed by stage 960 of responding to the determination. Stage 960 can include displaying information representative of the determination, generating an audio alert representative of the determination, preventing a weapon from detonating on a friend, allowing a weapon to detonate on a suspected foe, preventing a weapon from firing on a friend, allowing a weapon to fire on a suspected foe.

According to an embodiment of the invention the reception of the RF response signal, the transmission of the RF interrogation signal can be done by a second array of antennas. It is noted that the second array of antennas can be activated in parallel to the first array of antennas or serially. Thus, the RF response signal can be received by both arrays of antennas and their reception signals can be provided in parallel or in a serial manner to the reception signal. This illustrated by stage 970. The second array of antennas may include a plurality of antennas, wherein main antenna lobes of different antennas of the second array partially overlap to define a second array lobe. The beamwidth of the second array lobe is smaller than a beamwidth of each main antenna lobe of the different antennas of the second array. The first frequency range of the first array of antennas differs from a second frequency range of the second array of antennas.

Stage 970 includes receiving receiving, by the second array of antennas, the RF response signal from the entity. Stage 970 may be followed by stage 950.

The systems and method can classify an entity as a friend and if not—can classify it as a foe or another class.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. An identification system, comprising:
a first array of antennas that comprises a plurality of antennas, wherein main antenna lobes of different antennas of the first array partially overlap to define a first array lobe; wherein a beamwidth of the first array lobe is smaller than a beamwidth of each main antenna lobe of the different antennas of the first array;
a transmission circuit arranged to provide to the first array of antennas a radio frequency (RF) interrogation signal;
a reception circuit arranged to receive an RF response signal from an entity to be classified as a friend and to provide an electrical representation of the RF response signal; and
a processor, arranged to process the response signal and to determine, based on the electrical representation of the RF response signal, whether the entity is a friend.

2. The identification system, according to claim 1 wherein the first array of antennas comprises at least three different antennas.

3. The identification system according to claim 1, wherein the main antennas are shaped and positioned so that first array lobe is defined by an overlap of all of the main lobes of all of the antennas of the first array.

4. The identification system according to claim 1, wherein the first array of antennas comprises a first array lobe alteration circuit arranged to alter at least one characteristic of at least one main lobe of the antennas of the first array of antennas such as to alter at least one first array lobe characteristic selected from a group consisting of a direction of the first array lobe, a beamwidth of the first array lobe and a shape of the first array lobe.

5. The identification system according to claim 1, arranged to provide to the first array of antennas an encoded RF interrogation signals and wherein either one of the reception circuit and the processor is arranged to decode an encoded response signal.

6. The identification system according to claim 1, wherein either one of the reception circuit and the processor is arranged to extract from the response signal status information relating to the entity.

7. The identification system according to claim 1, further comprising a unidirectional antenna.

8. The identification system according to claim 1, wherein the processor is arranged to evaluate a distance to the entity based on (a) time lapsed between a transmission of the RF interrogation signal and a reception of the response signal, and (b) a delay introduced by the entity between a reception the RF interrogation signal and a transmission of the response signal.

9. The identification system according to claim 1, wherein the processor is coupled to a fire control element, and wherein the processor is arranged to instruct the fire control element to prevent a detonation of ammunition or firing towards the entity, if the processor determines that the entity is a friend.

10. The identification system according to claim 1, wherein the first array of antenna comprises antennas that are selected from a group consisting of Helli-coil antennas, patch antennas, dielectric rod antennas, Yagi-Huda monopole antenna and surface wave antennas.

11. The identification system according to claim further comprising:
a second array of antennas that comprises a plurality of antennas, wherein main antenna lobes of different antennas of the second array partially overlap to define a second array lobe; and
wherein a beamwidth of the second array lobe is smaller than a beamwidth of each main antenna lobe of the different antennas of the second array;
wherein a first frequency range of the first array of antennas differs from a second frequency range of the second array of antennas.

12. The identification system, according to claim 11 wherein the second array of antennas comprises at least three different antennas.

13. The identification system according to claim 11, wherein a central frequency of the first frequency range differs from an integer multiple of a central frequency of the second frequency range and wherein the central frequency of the second frequency range differs from an integer multiple of the central frequency of the first frequency range.

14. The identification system according to claim 11, wherein the first frequency range comprises a frequency of 2.4 Giga-Hertz and wherein the second frequency range comprises a frequency of 24 Giga-hertz.

15. The identification system according to claim 11, wherein the first frequency range comprises at least one frequency out of a frequency range of 70-90 Gigahertz and wherein the second frequency range comprises at least one frequency out of a frequency range of 0.4-2.4 Gigahertz.

16. The identification system according to claim 11, wherein the second array of antennas comprises a second array lobe alteration circuit arranged to alter at least one characteristic of at least one main lobe of the antennas of the second array of antennas such as to alter at least one second array lobe characteristic selected from a group consisting of a direction of the second array lobe, a beamwidth of the second array lobe and a shape of the second array lobe.

17. The identification system according to claim 1, wherein the first array of antennas is encloses in a cylindrical housing having a radius that does not exceed 3 centimeters and having a length that does not exceed 30 centimeters.

18. The identification system according to claim 1, wherein an overall angular coverage obtained by all of the antennas of the first array exceeds 10 degrees by 10 degrees while the angular coverage of the first array lobe does not exceed 1 degrees by 1 degrees.

19. The identification system according to claim 1, wherein the transmission circuit is arranged to provide in parallel the RF interrogation signal to all of the antennas of the first array of antennas.

20. The identification system according to claim 1, wherein the transmission circuit is arranged to provide the RF interrogation signal to different antennas of the first array of antennas in a sequential manner.

21. A method for classifying an entity as a friend, the method comprising:
providing, by a transmission circuit and to a first array of antennas, a radio frequency (RF) interrogation signal; wherein the first array of antennas comprises a plurality of antennas, wherein main antenna lobes of different antennas of the first array partially overlap to define a first array lobe; wherein a beamwidth of the first array lobe is smaller than a beamwidth of each main antenna lobe of the different antennas of the first array;
transmitting by the first array of antennas the RF interrogation signal;
receiving, by the first array of antennas, a RF response signal from the entity; and
determining, based on the RF response signal, whether the entity is a friend.
